(19) United States
(12) Patent Application Publication
(10) Pub. No.: US 2009/0243911 A1
(43) Pub. Date: Oct. 1, 2009

(54) METHOD AND DEVICE FOR POSITIONING AIRCRAFT, SUCH AS FOR AUTOMATIC GUIDING DURING THE LANDING PHASE

(75) Inventors: Pascal Cornic, St Renan (FR); Patrick Garrec, Merignac (FR); Philippe Lacomme, Igny (FR)

Correspondence Address: LOWE HAUPTMAN & BERNER, LLP, 1700 DIAGONAL ROAD, SUITE 300, ALEXANDRIA, VA, 22314, US

(73) Assignee: Thales, NEUILLY SUR SEINE (FR)

(21) Appl. No.: 11/719,839

(22) PCT Filed: Nov. 15, 2005
(86) PCT No.: PCT/EP05/55975

§ 371 Date: Mar. 10, 2009

(30) Foreign Application Priority Data
Nov. 19, 2004 (FR) 04 12313

(51) Int. Cl. G01S 13/91

(52) U.S. Cl. 342/36

(57) ABSTRACT

The present invention relates to a method and a device for locating aircraft. A radar (3) performs distance and angle location of the aircraft. Location is refined by means of at least one airborne beacon (4) aboard the aircraft and of at least one beacon (5) whose position is predetermined with respect to the radar (3), the measurement of the position of the airborne beacon (4) being performed by the radar (3) by differential measurement between the position of at least one ground beacon (5) and of at least one airborne beacon (4). The invention is in particular used for the automatic guidance of drones in the approach and landing phase.

### CROSS-REFERENCE TO RELATED APPLICATIONS

The present Application is based on International Application No. PCT/EP2005/055975, filed on Nov. 15, 2005, which in turn corresponds to French Application No. 04 12313, filed on Nov. 19, 2004, and priority is hereby claimed under 35 USC §119 based on these applications. Each of these applications are hereby incorporated by reference in their entirety into the present application.

### FIELD OF THE INVENTION

The present invention relates to a method and a device for locating aircraft, in particular for their automatic guidance in the landing phase. The invention relates for example to the guidance of drones in the approach and landing phase.

### BACKGROUND OF THE INVENTION

Solutions are known for automatically guiding aircraft, in particular drones, in the landing phase. A first solution uses the GPS (Global Positioning System) or DGPS (Differential Global Positioning System). This solution poses the problem of service availability or continuity. Additionally its vulnerability in the presence of jammers is known.

A second solution is based on the use of lasers. This laser-based solution does not offer all-weather performance. Moreover the narrow laser pencil requires a large number of scans to detect a target, therefore a more or less long search phase. It should be noted additionally that absolute positioning with respect to the runway is compulsory.

Another known solution uses very directional millimetre radars which likewise require a search phase for the designation of objectives and absolute positioning with respect to the runway. This radar solution which calls upon conventional tracking radar techniques in particular those using radars with servomechanisms, are expensive and difficult to implement. It additionally presents other drawbacks. In particular, in the event of multiple objectives, it is necessary to share the time and operate target-to-target homing at the risk of losing a target and of having to effect complete acquisition of the context. In the approach phase, the guidance constraints for keeping the target in the radar beam are very significant. The consequences of losing this target can be dramatic. Finally, having regard to propagation losses in the millimetre domain, it is necessary to use a transponder onboard the drone, this transponder transmitting permanently, which is not prudent. It should also be added that the presence of this transponder decreases the reliability of the guidance system. Specifically, in the event of transponder failure, there is a break in the downlink from the transponder to the radar, thereby blinding the radar.

### SUMMARY OF THE INVENTION

An aim of the invention is in particular to alleviate the aforesaid drawbacks. For this purpose, the invention is aimed at a method of locating an aircraft comprising:
a first step of locating the aircraft in terms of distance and angle by means of a radar;
a second step for refining the location by means of at least one airborne beacon aboard the aircraft and of at least one beacon whose position is predetermined with respect to the radar, the measurement of the position of the airborne beacon being performed by the radar by differential deviometry between the position of at least one ground beacon and of at least one airborne beacon.

Advantageously, the radar operates in continuous and simultaneous transmission and reception mode, the radar waveform comprising frequency plateaux fₚ inserted between frequency ramps, the frequency fₚ being detected by the beacons, the beacons retransmitting towards the radar a signal of frequency f₁, f₂ shifted by a fixed frequency Δf specific to each of the beacons. A frequency plateau is for example inserted between each ramp. It can be also inserted following several ramps.

Advantageously, the signal transmitted during the frequency plateaux is modulated so as to code messages destined for the beacons. The triggering of transmission of an airborne beacon can be caused by such a message.

Distance and angle location is for example performed on the frequency ramps. Distance and angle location begun in the first step continues in the second step. In the second step, the radar being of monopulse type, it measures for example the angular positions of the beacons, a deviometry pathway being reserved for each beacon. The first step begins for example in a landing runway approach phase.

The invention is also aimed at a device for locating an aircraft comprising:
a radar performing distance and angle location of the aircraft;
at least one airborne beacon aboard the aircraft and at least one beacon whose position is predetermined with respect to the radar so as to refine the location, the measurement of the position of the airborne beacon being performed by the radar by differential measurement between the position of at least one ground beacon and of at least one airborne beacon.

The main advantages of the invention are that it is simple to implement, that it is economical and that it allows very reliable location.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, an aircraft in the landing phase wherein are depicted components of a device according to the invention;

FIG. 2, the position of an aircraft in the terminal approach phase facing the runway and components of a device according to the invention;

FIG. 3, an example of a first waveform of a radar used for the invention;

FIG. 4, an example of a second waveform of a radar used for the invention;

FIG. 5, an exemplary phase-locking device used in an airborne beacon onboard the aircraft;

FIG. 6, an exemplary waveform conveying a coded message.

### DETAILED DESCRIPTION OF THE INVENTION

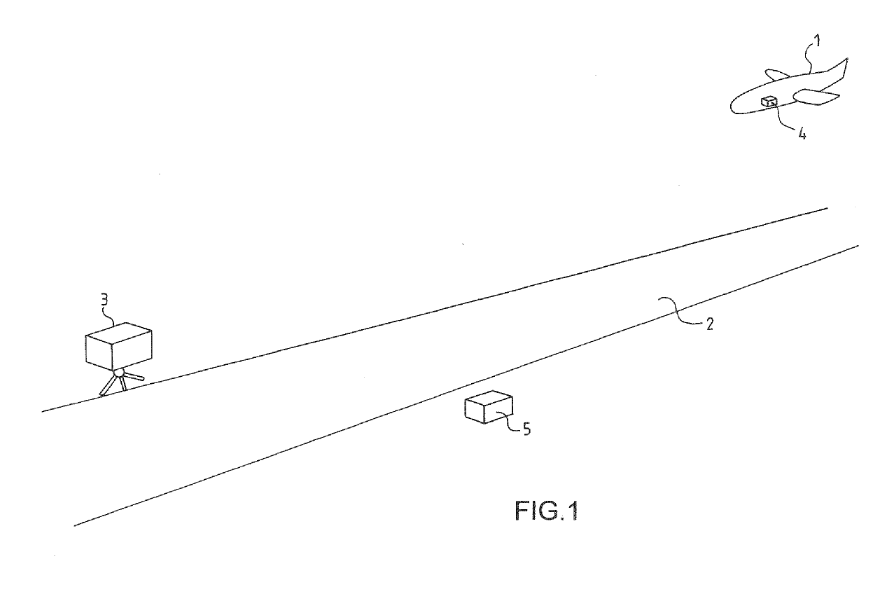

FIG. 1 presents an aircraft 1 in the phase of landing on a runway 2. Subsequently, it will be considered by way of example that the aircraft is a drone. Additionally, FIG. 1 illustrates elements of a device according to the invention. The device comprises at least:
a ground radar 3, preferably with a wide detection cone, for example of the order of 20°;
an airborne beacon 4 onboard the drone 1, this beacon makes it possible in particular for the target formed by the drone to be rendered point-like;
a ground beacon 5 which serves in particular as reference, as will be shown subsequently.

These elements make it possible to calculate the position of the drone up to complete landing. The drone is thereafter guided by conventional guidance means on the basis of its calculated position. The radar 3 and the ground beacon 5 are disposed in proximity to the runway 2.

In the approach phase, the drone penetrates into the lobe of the antenna of the radar 3. The start of this phase begins for example in the vicinity of an altitude of 1000 metres on the approach to the runway 2, at 5000 metres from the latter. Before this phase the position of the drone can be detected by conventional means such as the GPS system. From the approach phase onwards, the accuracy requirements become greater and greater.

A method according to the invention comprises at least two steps. In a first step, the drone is located in distance and angle by the radar 3, with an almost nondirectional beam, during the initial approach phase. The location accuracy requirement is modest in the course of this phase. Accuracy of no more than a few metres to a few tens of metres is required. Angular location of the drone can be performed for example by deviometry. For this purpose, the radar used is for example a monopulse radar. The measurement of the distance of the drone from the radar is done for example in a conventional manner by means of distance windows.

In a second step, the location of the drone is refined with the aid of the ground beacon 5 and the airborne beacon 4 aboard the drone transmitting towards the radar. To instigate this second step, it is necessary to activate the airborne beacon 4 aboard the drone. The beacon 4 can be activated automatically from onboard the drone by detecting radar transmission or on the basis for example of a command from a monitoring station.

The second step therefore occurs in the terminal approach and landing phase. The angular accuracy requirement in particular is here extremely significant, from one to a few milliradians. The position information provided by the radar 3 is then no longer accurate enough. In the example of FIG. 1, a single ground beacon and a single airborne beacon are represented, but if need be other ground beacons or other airborne beacons can be used. The measurement of the angle of approach, in azimuth and in elevation, is performed by the radar by differential measurement between the position of at least one ground beacon 5 and of at least one airborne beacon 4. The measurement of the distance can for example be performed on the skin echo of the drone or else on the signal of the airborne beacon if the latter is operating in transponder mode.

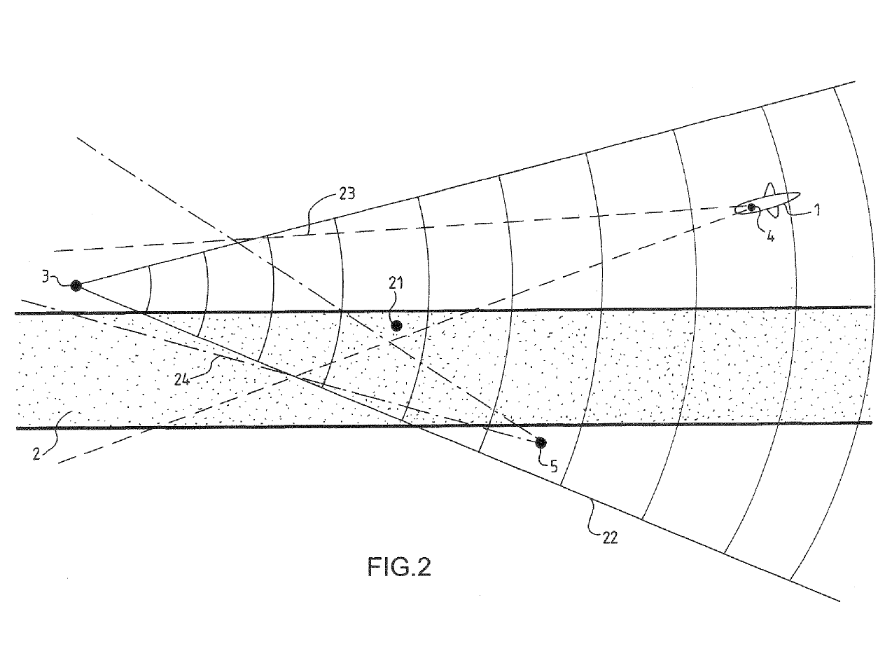

FIG. 2 illustrates the drone 1 in the terminal approach phase above the runway 2 heading towards a predetermined touchdown point 21. The elements of the guidance device are represented by their position. The radar 3 and the ground beacon 5 are for example disposed in proximity to the edge of the runway. The beam 22 of the radar 3 covers both the drone 1 and the ground beacon 5. Likewise, the radar 3 is situated in the beam 23 of the airborne beacon 4 and in the beam 24 of the ground beacon 5. The radar can thus perform differential location between a point-like reference on the drone, this reference being the airborne beacon 4, and another point-like ground reference formed by the beacon 5. For this purpose, the radar comprises for example two deviometry pathways for making on the one hand deviometry measurements on the beacon 4 onboard the drone and on the other hand deviometry measurements on the ground beacon 5. The deviometry pathways are for example established conventionally by computational beamforming or by monopulse processing.

The radar 3 calculates the position of the airborne beacon 5 with respect to the touchdown point 21. The radar also calculates the position of the ground beacon 5 with respect to the touchdown point 21. This position is moreover perfectly known. In these two measurements performed by the radar, there is the same location error. Exact location of the airborne beacon 4 is thereafter achieved by deducting the aforesaid location error from the result of the measurement. This differential measurement therefore makes it possible to eliminate the errors of alignment of the drone with respect to a given trajectory which the predetermined touchdown point 21 will encounter. The ground beacon 5 therefore serves as reference and allows the radar deviometer to work in false zero mode and to estimate the relative target angles with respect to this beacon 5. The angle of approach is therefore measured by the radar by differential measurement between the position of the ground beacon 5 and of the airborne beacon 4. Moreover, knowing the distance by means of the radar processing engaged during the first step, the substantially exact position of the aircraft is deduced therefrom. Specifically, during this terminal phase, the radar processing is not interrupted. In addition to the processing by deviometry of the signals transmitted by the beacons 4, 5, the distance and Doppler processing on the drone skin echoes continues. In particular to maintain the drone in the landing corridor.

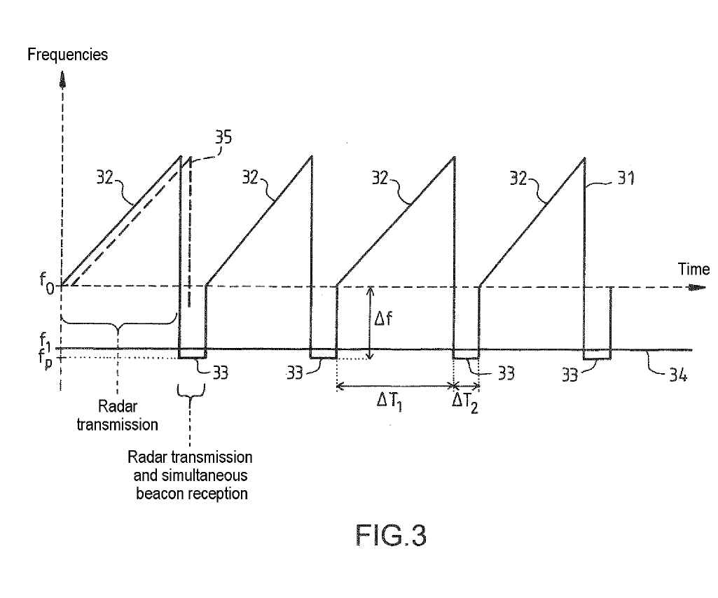

FIG. 3 presents an exemplary waveform of a radar 3 used in a device according to the invention. A curve 31 represents this radar waveform by its transmission frequency as a function of time. The radar transmission is continuous since on account of the short range of the application, blind zones are not permissible.

This wave 31 comprises a string of ramps 32. Each ramp has a duration of ΔT₁. A plateau 33 of duration ΔT₂ is inserted between each ramp. This plateau of constant frequency fₚ is shifted by a frequency Δf with respect to the frequency f₀ of origin of the ramps. Such a waveform allows the radar to perform at one and the same time conventional radar processing of the echo signals received from the drone and processing of the signals transmitted by the beacons 4, 5 for more accurate deviometry measurements. These beacons 4, 5 transmit a fixed frequency represented by a plateau 34. To simplify the figure, the two beacons are assumed to transmit at the same frequency, in reality they transmit at different frequencies so as to allow the radar to distinguish between them.

The frequency ramps allow the conventional processing, that is to say a radar transmission assigned to the distance and Doppler processing of the skin echo of the drone. A curve 35 represents the reception wave received corresponding to the transmitted wave 32. After a ramp 32, the wave transmitted by the radar is switched over to the fixed frequency fₚ so as to illuminate the beacon 4 of the drone and the ground beacon 5. The signal detected by the beacons will be the signal formed by the successive plateaux 33 inserted between the ramps. It is on the basis of the signals retransmitted by the beacons that it will be possible to perform the more accurate deviometry measurements.

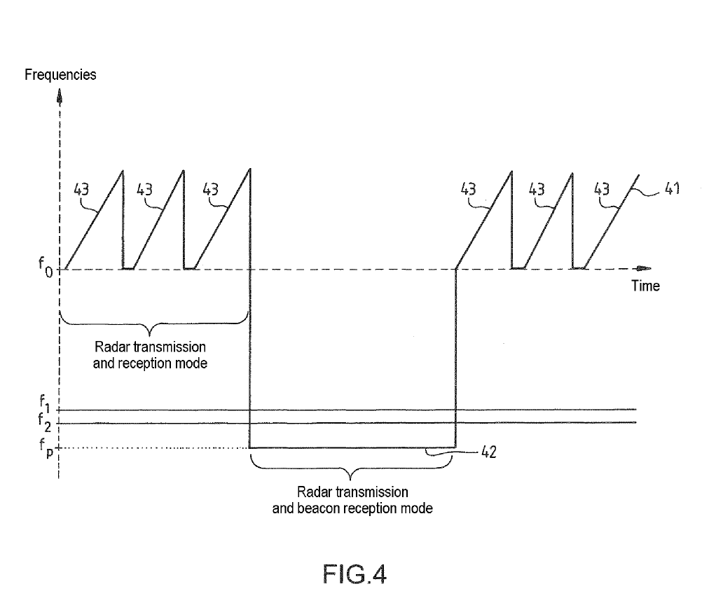

FIG. 4 presents another exemplary radar waveform by a curve 41. For this waveform, a frequency plateau 42 is no longer inserted between each frequency ramp but between groups of several ramps 43. With this waveform the plateau at the frequency fₚ is longer, that is to say it has a noticeably greater duration than the duration ΔT₂ of a plateau 33 of the previous example. This makes it possible in particular to allocate a larger detection time to the beacons. By way of example the radar transmission and reception mode corresponding to the frequency ramps 43 lasts of the order of 25 milliseconds. The radar transmission and reception mode for the signals of the beacons can have the same duration as the other mode. The durations of the two modes can also be adjusted in the course of the tracking phase so as to optimize the quality of reception as a function of flight situation. In FIG. 4 the two plateaux 44, 45 of frequency f₁ and f₂ of the two beacons 4, 5 are represented. The radar 3 comprises matched filters suitable for separating the two frequencies. Each frequency, or rather its corresponding signal, is thereafter guided towards its deviometry pathway. Thus the signal arising from the ground beacon 5 is switched towards the deviometry pathway reserved for this beacon and the signal arising from the airborne beacon 4 is switched over to the other deviometry pathway. The two matched filters make it possible to identify the signals originating from each of the beacons. Having identified from where these signals originate, the radar thereafter performs deviometry measurements on these signals and can without ambiguity allocate them to the locating of the ground beacon 5 and to the locating of the airborne beacon 4. The frequencies f₁, f₂ transmitted by the beacons 4, 5 are in fact the responses of these beacons at the frequency fₚ transmitted by the radar during the plateaux 33, 43.

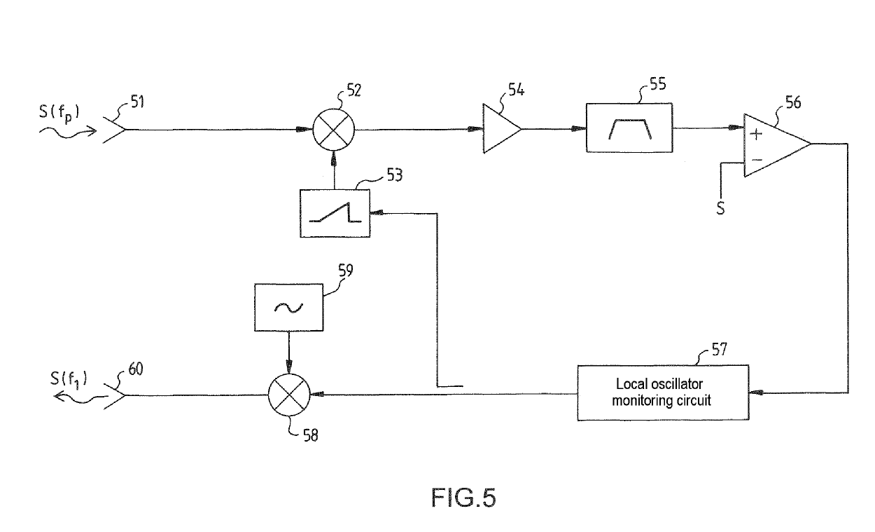

FIG. 5 presents an exemplary circuit incorporated into the beacons which makes it possible to obtain these response frequencies f₁, f₂. This circuit is a conventional circuit, the principle of which is recalled in FIG. 5. It forms a phase-lock loop so as to allow a continuous transmission phase locked on a predefined channel. The beacons thus retransmit a frequency f₁, f₂ shifted by a fixed frequency with respect to the frequency fₚ received from the radar.

A reception antenna 51 therefore picks up the signals S(fₚ) of frequency fₚ transmitted by the radar 3. The signal received enters a first hyperfrequency mixer 52, which additionally receives the signal of the local oscillator 53, whose frequency is linearly modulated as a function of time in the course of the radar signal search phase. The mixed signal feeds into an amplifier 54 then a bandpass filter 55. The output of the bandpass filter is compared with a threshold S by a detector 56 based on an operational amplifier or digital circuits if the output signal of the filter is digitized.

The bandpass filter is centred on an expected beat frequency f_{b}, between the frequency transmitted by the radar 3 and the frequency generated by the local oscillator so as to allow the beacon to detect the presence of the signals transmitted by this radar. Once the radar frequency has been detected, the frequency of the local oscillator is slaved to the radar frequency by way of a monitoring circuit 57. It would be better in FIG. 5 to replace the box 3 by a box entitled local oscillator monitoring circuit. The transfer function of the circuit 57 is thereafter applied to the output signal of the detector. A part of the signal is looped back to the input of the local oscillator 53. The other part of the signal feeds into a second mixer 58 which adds a frequency Δf provided by a fixed-frequency oscillator 59.

The second oscillator might not be used. In this case it is possible to slave the local oscillator directly to the sought-after beat frequency f_{b}=Δf. In this case, the output of the first oscillator 53 is also connected to the transmission antenna 60. It is also necessary to envisage a switch controlled by the monitoring circuit 57 making it possible to activate or to disable the beacon transmission towards the radar, this switch is for example disposed between the output of the first oscillator 53 and the transmission antenna 60.

The output signal of the second mixer is transmitted by the transmission antenna 60. The signal S(f₁) is transmitted by the antenna 60 towards the radar 3, this signal being utilized by the radar for the differential measurements. The frequency of this signal is the characteristic frequency f₁ of a beacon. Each beacon transmits its own frequency f₁, f₂ determined by the frequency Δf of the fixed oscillator 59. Depending on the beacon, Δf=f₁−fₚ or Δf=f₂−fₚ.

The transmission of the beacons can be triggered automatically by detecting the radar signal or by a signal transmitted by a ground station. The power transmitted by the beacons is for example of the order of a milliwatt. The antennas of the beacons can be of printed circuit type, their dimensions being for example of the order of 10 cm×10 cm.

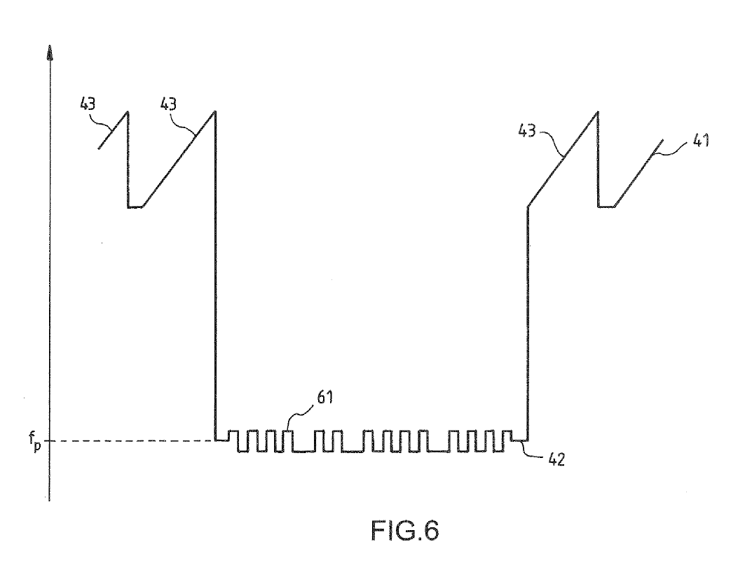

FIG. 6 illustrates another possible radar waveform. The waveform is as a whole for example the same as that of FIG. 4. However, the signal transmitted during the frequency plateaux 42 is modulated about the frequency fₚ of this plateau. This modulation serves for example to code messages 61 destined for the beacons. In particular this code can contain the transmission order for the beacons. Other operational messages can obviously be dispatched.

A method, or a device, according to the invention therefore allows a drone to be guided with the aid of information delivered by the detection and the tracking performed by the radar 3 in the first approach phase, for example in a cone with radar aperture of the order of 20°. Onwards of the final approach phase, a few hundred metres from the runway touchdown point for example, final guidance is carried out with the aid of the same radar 3 associated with the two beacons 4, 5 transmitting in the radar band. A single airborne beacon 4 and a single ground beacon 5 may suffice. Nevertheless, for operational safety reasons, several beacons may be used, for example two airborne beacons and two ground beacons.

The radar 3 used can be made by low-cost X-band technology. For this purpose, the radar transmitter may be solid-state. The generation of the radar waveforms is performed on the basis of digital circuits allowing frequency and waveform agility while ensuring phase consistency with very high stability, thereby increasing in particular Doppler effect-based target extraction performance. The frequency agility is of such a nature as to boost the discretion of the radar transmission, to increase the quality of detection and tracking, for example in the presence of reflections on the sea. Still with the aim of reducing costs, the antenna of the radar is for example fixed without any mechanical slaving device. Specifically, once positioned on the ground, the radar observes in one direction only, this direction relating to that of the runway. If necessary, in particular in the event of installation on a carrier, compensation for the movements of the carrier can be performed easily with the aid of integrated circuit gyrometric sensors and accelerometers positioned on the back of the radar antenna. The information from these sensors is then used to correct the coordinates estimated by the radar.

Advantageously, the X-band is very insensitive to meteorological disturbances and guarantees all-weather operation of the device, unlike infra-red sensors or radars in the millimetre band for example.

It should be noted that location of the drone during the initial approach phase is performed with the aid of an autonomous device from the ground without the need for active cooperation aboard the drone, thereby strengthening operational safety. In the course of the final approach phase, the responder beacons can be activated at very short distance, and in a very directional manner, thereby enabling the link to be made as secure as possible. During this final approach phase, the conventional radar function remains active and there is therefore redundancy of the radar and beacon information, further increasing the reliability of the device.

The method and the device according to the invention have been described for a landing phase, they can nevertheless be applied to other flight phases, in particular to takeoff.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method of locating an aircraft, comprising:
a first step of locating the aircraft in terms of distance and angle by means of a radar;
a second step for refining the location by means of at least one airborne beacon aboard the aircraft and of at least one ground beacon whose position is predetermined with respect to the radar, the measurement of the position of at least one airborne beacon being performed by the radar by differential measurement between the position of at least one ground beacon and of at least one airborne beacon.

2. The method according to claim 1, wherein the radar waveform comprises frequency plateaux fₚ inserted between frequency ramps, the frequency fₚ being detected by the beacons, the beacons retransmitting towards the radar a signal of frequency (f₁, f₂) shifted by a fixed frequency (Δf) specific to each of the beacons.

3. The method according to claim 2, wherein a frequency plateau is inserted between each ramp.

4. The method according to claim 2, wherein a plateau is inserted following several ramps.

5. The method according to claim 2, wherein the signal transmitted during the frequency plateaux is modulated so as to code messages destined for the beacons.

6. The method according to claim 5, wherein the triggering of transmission of an airborne beacon is caused by a message.

7. The method according to claim 2, wherein distance and angle location is performed on the frequency ramps.

8. The method according to claim 1, wherein distance and angle location begins in the first step and continues in the second step.

9. The method according to claim 1, wherein in the second step, the radar being of monopulse type, it measures the angular positions of the beacons, a deviometry pathway being reserved for each beacon.

10. The method according to claim 1, wherein the first step begins in a landing runway approach phase.

11. The method according to claim 1, wherein the aircraft is a drone.

12. A device for locating an aircraft, comprising:
a radar performing distance and angle location of the aircraft;
at least one airborne beacon aboard the aircraft and at least one ground beacon whose position is predetermined with respect to the radar so as to refine the location, the measurement of the position of at least one airborne beacon being performed by the radar by differential measurement between the position of at least one ground beacon and of at least one airborne beacon.

13. The device according to claim 12, wherein the radar waveform comprises frequency plateaux fₚ inserted between frequency ramps, the frequency fₚ being detected by the beacons, the beacons retransmitting towards the radar a signal of frequency (f₁, f₂) shifted by a fixed frequency (Δf) specific to each of the beacons.

14. The device according to claim 13, wherein a frequency plateau is inserted between each ramp.

15. The device according to claim 13, wherein a plateau is inserted following several ramps.

16. The device according to claim 13, wherein the signal transmitted during the frequency plateaux is modulated so as to code messages destined for the beacons.

17. The device according to claim 16, wherein the triggering of transmission of an airborne beacon is caused by a message.

18. The device according to claim 13, wherein distance and angle location is performed on the frequency ramps.

19. The device according to claim 12, wherein distance and angle location continues during the differential measurements performed with the aid of the beacons.

20. The device according to claim 12, wherein the radar being of monopulse type, it comprises at least two deviometry pathways, a first deviometry pathway being reserved for an airborne beacon transmitting at a first frequency (f₁) and a second deviometry pathway being reserved for a ground beacon transmitting at a second frequency (f₂), the radar performing the beacon angular position measurements.

21. The device according to claim 12, wherein location is performed in a landing runway approach phase.

22. The device according to claim 12, wherein the aircraft is a drone.
